(19) United States
(12) Patent Application Publication
(10) Pub. No.: US 2015/0006175 A1
(43) Pub. Date: Jan. 1, 2015

(54) APPARATUS AND METHOD FOR RECOGNIZING CONTINUOUS SPEECH

(71) Applicant: ELECTRONICS AND TELECOMMUNICATIONS RESEARCH INSTITUTE, Daejeon (KR)

(72) Inventors: Ki-Young PARK, Daejeon (KR); Yun-Keun LEE, Daejeon (KR); Hoon CHUNG, Daejeon (KR)

(73) Assignee: ELECTRONICS AND TELECOMMUNICATIONS RESEARCH INSTITUTE, Daejeon (KR)

(21) Appl. No.: 14/304,104

(22) Filed: Jun. 13, 2014

(30) Foreign Application Priority Data
Jun. 26, 2013 (KR) 10-2013-0073990

(51) Int. Cl. G10L 15/18

(52) U.S. Cl. CPC G10L 15/18; G10L 2015/0631
USPC 704/245

(57) ABSTRACT

The present invention relates to an apparatus and a method for recognizing continuous speech having large vocabulary. In the present invention, large vocabulary in large vocabulary continuous speech having a lot of same kinds of vocabulary is divided to a reasonable number of clusters, then representative vocabulary for pertinent clusters is selected and first recognition is performed with the representative vocabulary, then if the representative vocabulary is recognized by use of the result of first recognition, re-recognition is performed against all words in the cluster where the recognized representative vocabulary belongs.

### CROSS-REFERENCE TO RELATED APPLICATIONS

This application claims the benefit of Korean Patent Application No. 10-2013-0073990, filed with the Korean Intellectual Property Office on Jun. 26, 2013, the disclosure of which is incorporated herein by reference in its entirety.

### BACKGROUND

1. Technical Field

The present invention relates to an apparatus and a method for recognizing continuous speech, more specifically to an apparatus and a method for recognizing continuous speech having a large volume of vocabulary.

2. Background Art

Nowadays, the speech recognition technology is used in a vehicle to operate various kinds of equipment. The most typical use of the speech recognition technology is for recognizing destination place names. Recently, systems for recognizing continuous speech have been increasingly utilized for the speech recognition system in motor vehicles.

The conventional system for recognizing continuous speech extracts a frequency of occurrence of a word or a word array by use of statistics information of collected sentences, calculates a probability of occurrence of the word or the word array using this extracted frequency of occurrence, and then uses the information of probability of occurrence in the step of speech recognition.

However, there can be millions of possible vocabularies when destination place names are recognized. In addition, it is assumed that most vocabularies have the same probability of occurrence because they have little differences in the probability of occurrence between the words or word arrays, and the probability of occurrence becomes very low in inverse proportion to the number of vocabularies. Accordingly, the conventional system in the vehicle cannot recognize the destination place names properly.

Korean Publication Patent No. 2009-0065102 (METHOD AND APPARATUS FOR LEXICAL DECODING) suggests a system for recognizing speech employing a cluster. However, the method suggested in Korean Publication Patent No. 2009-0065102 is suitable to recognize an isolated word but is not suitable to recognize continuous speech.

### SUMMARY

The present invention provides an apparatus and a method for recognizing continuous speech that can recognize sentence patterns having a user's intention by use of representative words selected from an entire vocabulary and can finally recognize continuous speech having a large volume of vocabulary by use of the recognized sentence patterns and their similar words.

However, the present invention shall by no means be restricted by the present descriptions and shall be clearly understood through the following descriptions.

An apparatus for recognizing continuous speech in accordance with the present invention includes: a cluster creation portion configured to create clusters which include at least one of vocabulary from continuous speech; a representative vocabulary extraction portion configured to extract at least one of representative vocabulary from each cluster; a continuous speech primary recognition portion configured to recognize the continuous speech primally based on the extracted representative vocabularies and to produce a recognition result; and a continuous speech final recognition portion configured to recognize the continuous speech finally based on the produced recognition result.

The cluster creation portion creates lesser number of clusters than the number of vocabularies included in the continuous speech.

The cluster creation portion includes: a pronunciation array extraction portion configured to extract a pronunciation array from each vocabulary; and a quantization portion configured to create the clusters from the continuous speech according to vector quantization method by having the extracted pronunciation array as a vector.

The representative vocabulary extraction portion is configured to extract the representative vocabulary according to an appearance probability of vocabulary in the cluster or in the continuous speech.

The continuous speech final recognition portion is configured to recognize the continuous speech finally by use of vocabularies not being extracted as the representative vocabularies.

The apparatus for recognizing continuous speech also includes a language model creation portion configured to create a language model for speech recognition having the extracted representative vocabularies.

The apparatus for recognizing continuous speech is used to recognize destination place names as being installed in a navigation system.

A method for recognizing continuous speech in accordance with the present invention includes: creating clusters which include at least one of vocabulary of continuous speech; extracting at least one of representative vocabulary from each cluster; producing a recognition result by recognizing the continuous speech primally based on the extracted representative vocabularies; and recognizing the continuous speech finally based on the produced recognition result.

The creating clusters create lesser number of clusters than the number of vocabularies included in the continuous speech.

The creating clusters includes: extracting a pronunciation array from each vocabulary; and creating the clusters from the continuous speech according to vector quantization method by having the extracted pronunciation array as a vector.

The extracting representative vocabulary extracts the representative vocabulary according to an appearance probability of vocabulary in the cluster or in the continuous speech.

The recognizing continuous speech finally recognizes the continuous speech finally by use of vocabularies not being extracted as the representative vocabularies from the continuous speech.

The method in accordance with present invention also includes creating a language model having the extracted representative vocabularies between extracting representative vocabulary and the producing a recognition result.

The present invention can achieve the following effects.

Firstly, the recognition performance for continuous speech including a large vocabulary can be improved by recognizing sentence patterns having a user's intention by use of representative words selected from an entire vocabulary and by finally recognizing continuous speech having a large volume of vocabulary by use of the recognized sentence patterns and their similar words.

Secondly, the recognition speed can be improved by limiting the search space at the first recognition.

### BRIEF DESCRIPTION OF THE DRAWINGS

FIG. 1 is a block diagram showing an internal structure of an apparatus for recognizing continuous speech in accordance with an embodiment of the present invention.

FIG. 2 is a block diagram showing an added component to the apparatus for recognizing continuous speech shown in FIG. 1.

FIG. 3 is a flow diagram showing an example of utilizing the apparatus for recognizing continuous speech shown in FIG. 1.

FIG. 4 is a flow diagram showing a method for recognizing continuous speech in accordance with an embodiment of the present invention.

### DETAILED DESCRIPTION

Hereinafter, an embodiment of the present invention will be described in detail with reference to the accompanying drawings. Identical or corresponding elements will be given the same reference numerals, regardless of the figure number. Also if related announcements or specific explanations about structures are determined to distract the point of the present invention, the pertinent detailed explanations will be omitted. In addition, an embodiment of the present invention will be described hereinafter, but the technical ideas of the present invention shall by no means be restricted to it and various permutations are possible.

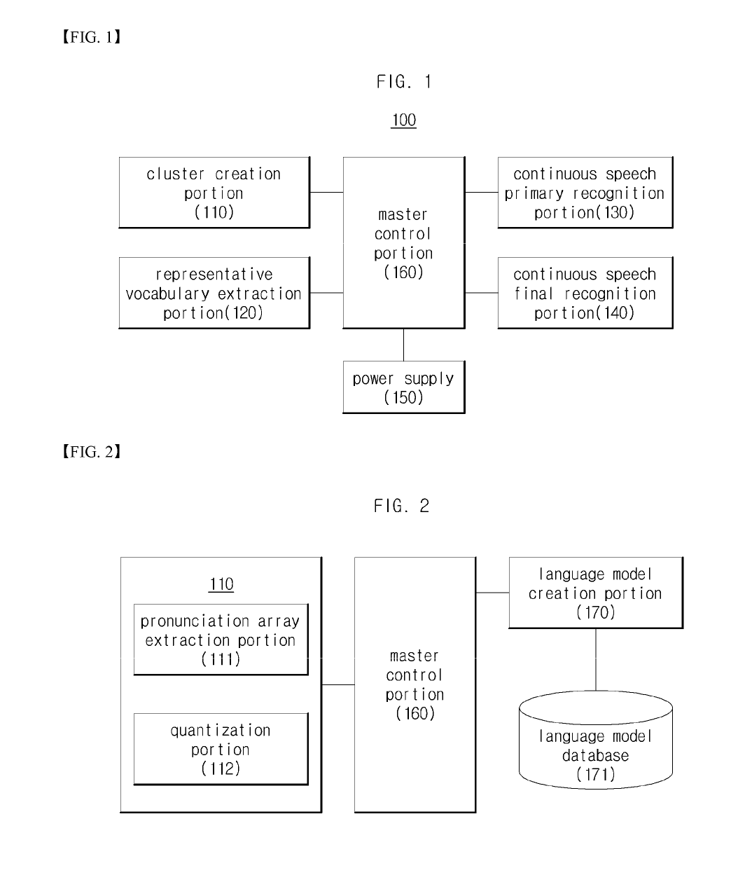

FIG. 1 is a block diagram showing an internal structure of an apparatus for recognizing continuous speech in accordance with an embodiment of the present invention.

In accordance with FIG. 1, an apparatus for recognizing continuous speech 100 includes a cluster creation portion 110, a representative vocabulary extraction portion 120, a continuous speech primary recognition portion 130, a continuous speech final recognition portion 140, a power supply 150, and a master control portion 160.

Speech as the most natural type of communication media used by human beings has great importance in representing ideas of a person or creating information. Therefore, needs of a Man-Machine Interface, which is a communication between a man and a machine by speech as a medium, has been highly raised and there have been a number of studies on speech recognition after the mid-1970s.

Until the beginning of 1980s, a speech recognition system had been developed based on artificial intelligence technique which realizes a knowledge that a person uses when he recognizes speech. After that, IBM developed an extensive scale speech recognition system by use of a statistical technique called HMM (Hidden Markov Model), and HMM has been a leading technique for speech recognition as being chosen in almost all large systems for speech recognition after mid-1980s.

Speech recognition after 1990s reaches to a level of understanding speech which surpasses simple recognizing to acknowledge meaning of speech and response to it, and this has been possible by combining speech recognition technology and natural language processing technology.

The speech recognition techniques can be categorized several ways in accordance with aspects of categorization.

First of all, it can be categorized as a speaker independent recognition technique and a speaker dependent recognition technique.

At first, the speaker dependent recognition system is for recognizing speech of a specific speaker and a voice dialing system installed in a mobile phone and being currently used is an example.

The speaker independent recognition system is for recognizing speech of a plurality of speakers, and it collects the speech of a plurality of speakers to make a statistical model learn, and performs recognition by use of the learned model.

There has been a recently developing technology called a speaker adaptation technique which has a speaker independent recognition system implemented and modifies the recognition model suitable to a speaker's speech when it operates.

Next, the speech recognition techniques can be divided by a pronunciation type as an isolating language recognition system and a continuous speech recognition system.

In the isolating language recognition system, each word is pronounced clearly and it is assumed that there is a silent interval with enough length between each word, and the recognition is focused on how much the each word is different with other words and an effect from an adjacent word is ignored.

On the contrary, in the continuous speech recognition system, the recognition is performed with a sentence as a unit, and each sentence is pronounced as is and there is no silent interval added between words. In the continuous speech, a characteristic of a word is affected by a pronunciation of an adjacent word, and it is called coarticulation effect. The coarticulation effect is a one of the major reasons to make the recognition of continuous speech difficult.

The present invention suggests an apparatus for recognizing continuous speech 100. The apparatus for recognizing continuous speech 100 is for accurately recognizing continuous speech having a large volume of vocabulary having the same probability, such as for recognizing destination place names. The apparatus for recognizing continuous speech 100 recognizes a sentence structure having a user's intention by use of representative vocabularies out of whole vocabularies, and after that performs re-recognition by use of similar vocabulary with a result of the recognition thereby improving performances and speeds of the recognition.

The cluster creation portion 110 performs a function of creating clusters having at least one vocabulary from continuous speech. The cluster creation portion 110 of the present embodiment can create less number of clusters than the number of vocabularies included in the continuous speech.

FIG. 2 is a block diagram showing an added component to the apparatus for recognizing continuous speech shown in FIG. 1.

The cluster creation portion 110 in accordance with FIG. 2 can include a pronunciation array extraction portion 111 and a quantization portion 112.

The pronunciation array extraction portion 111 extracts a pronunciation array from each vocabulary.

The quantization portion 112 creates clusters from continuous speech according to vector quantization method by having the pronunciation array extracted by the pronunciation array extraction portion 111 as a vector.

FIG. 1 will be referred again.

The representative vocabulary extraction portion 120 extracts at least one of representative vocabularies from each cluster.

The representative vocabulary extraction portion 120 can extract a representative vocabulary according to an appearance probability of vocabulary in the cluster or in the continuous speech. For example, when extracting a single representative vocabulary, the representative vocabulary extraction portion 120 extracts a vocabulary having the highest appearance probability in the clusters or in the continuous speech as the single representative vocabulary. Moreover, when extracting at least two representative vocabularies, the representative vocabulary extraction portion 120 extracts vocabularies of which appearance probability is higher than a base value as the representative vocabularies.

The continuous speech primary recognition portion 130 recognizes primarily the continuous speech based on the representative vocabularies extracted by the representative vocabulary extraction portion 120 and produces a result of the recognition.

The continuous speech final recognition portion 140 recognizes finally the continuous speech based on the result of the recognition produced by the continuous speech primary recognition portion 130. The continuous speech final recognition portion 140 can finally recognizes the continuous speech by use of vocabularies not being extracted as the representative vocabularies.

The power supply 150 supplies a power to each portion composing the apparatus for recognizing continuous speech 100.

The master control portion 160 controls all operations of the each portion composing the apparatus for recognizing continuous speech 100.

The apparatus for recognizing continuous speech 100 can further comprise a language model creation portion 170 as shown in FIG. 2.

The language model creation portion 170 creates a language model for speech recognition having the representative vocabularies extracted by the representative vocabulary extraction portion 120. Once the language model is created based on the representative vocabularies by the language model creation portion 170, the continuous speech primary recognition portion 130 recognizes the continuous speech primarily by use of the language model. The language model created by the language model creation portion 170 is stored in a language model database 171.

So far, the apparatus for recognizing continuous speech 100 in accordance with the embodiment has been described. The apparatus for recognizing continuous speech 100 in accordance with the present invention can be used to recognize the destination names as being installed in a navigation system.

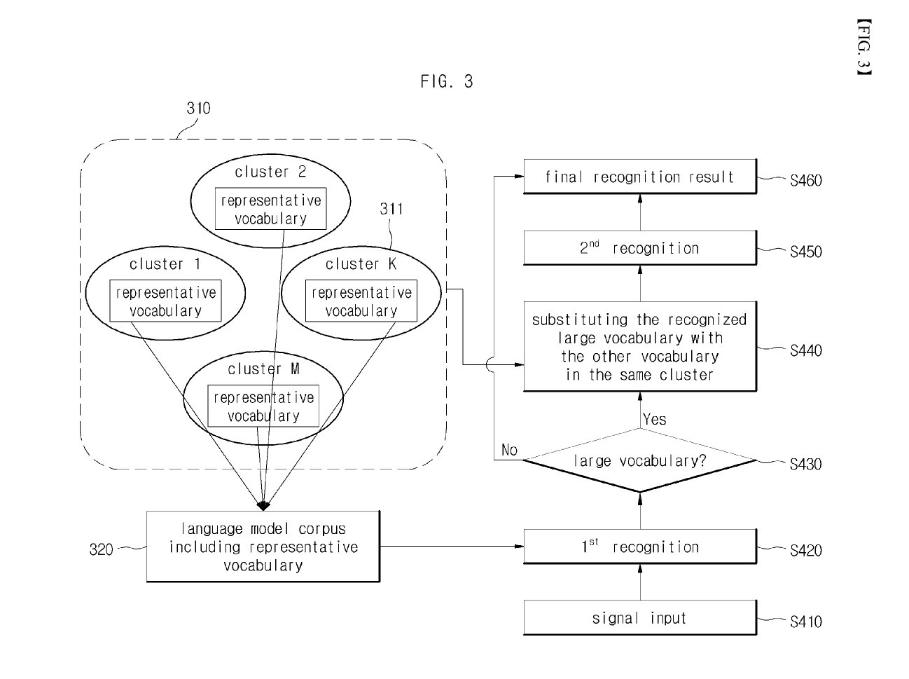

FIG. 3 is a flow diagram showing an example of utilizing apparatus for recognizing continuous speech shown in FIG. 1.

The apparatus for recognizing continuous speech having large vocabulary can operate as shown in FIG. 3 as an embodiment.

At first, when N large vocabularies 310 in total are input at S410, the N large vocabularies 310 are clustered as M groups such as cluster 1, cluster 2, . . . , cluster K, . . . , cluster M at step (a). The reference numeral 311 in FIG. 3 indicates a cluster.

Step (a) is for creating a group with words having a similar pronunciation array, and, for example, after pronunciation arrays of N vocabularies are extracted and each pronunciation array is considered as a vector, a vector quantization (VQ) method can be performed. The M is an integer less than N and can be pre-defined through experiments or can be decided automatically by being compared distances among each cluster in the vector quantization procedure.

After step (a), L representative vocabularies that is equal to or more than one are extracted for each cluster at step (b).

Step (b) is for extracting a word for a representative name for each cluster in the language model necessary for the first recognition at S420, and the representative name can be selected arbitrarily in the clusters or a word having a highest appearance probability in the clusters can be selected.

After step (b), a language model for speech recognition having L representative vocabularies is created at step (c).

At step (c), the language model is created as the same method as which is generally used for speech recognition. The language model corpus including representative vocabulary 320 means a language model created as this procedure.

When the language model is created, it is not created with all words in N large vocabularies, but with only M vocabularies. If there is a vocabulary of a population in the data for creating a language model, the language model is conditioned by being substituted with each representative vocabulary.

After step (c), the recognition is performed by use of the language model created with only representative vocabularies at S420, and then a result of the first recognition is produced at step (d).

At step (d), a general speech recognition is performed by use of the language model created at step (c). In this result, only L vocabularies out of N large vocabularies appear, and N-L vocabularies that are the rest vocabularies do not appear.

After step (d), the second recognition that includes words within the cluster where the result of the first recognition belongs to in the recognition subject vocabularies and re-recognizes the recognition subject vocabularies is performed at step (e).

Step (e) is extracting a final recognition result from the recognition result of step (e). Since it is possible in the result of first recognition that the other vocabulary could be pronounced in the position where the representative vocabulary is recognized, a recognition image is created at S430 and S440 in an assumption that the recognized representative vocabulary can be replaceable to other vocabulary, and then the final recognition result at S460 is produced after performing the re-recognition at S450.

The method described so far with reference to FIG. 3 can prevent from decreasing the recognition performance due to the increased number of vocabularies when the largely mixed similar kinds of vocabularies such as destination place names in a navigation system needs to be recognized. Moreover, the method can improve the recognition performance for recognizing continuous speech having large vocabulary, and can enhance the recognition speed by reducing a search space for recognizing.

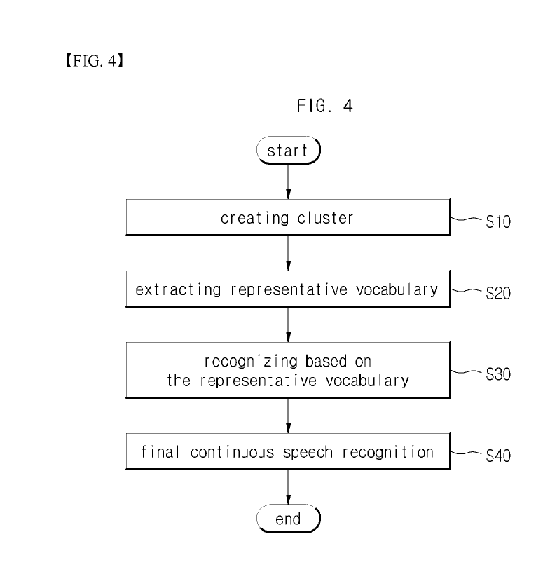

FIG. 4 is a flow diagram showing a method for recognizing continuous speech in accordance with an embodiment of the present invention.

At first, a large vocabulary in a large vocabulary continuous speech having a lot of same kinds of vocabularies is divided to a reasonable number of clusters. Then, the representative vocabulary for pertinent clusters is selected to perform the first recognition with the representative vocabulary. If the representative vocabulary is recognized by use of the result of first recognition, the re-recognition is performed with all words in the cluster where the recognized representative vocabulary belongs to. Detailed descriptions will be followed hereinafter.

First of all, the cluster creation portion creates clusters which include at least one of vocabulary of continuous speech at S10.

Then, the representative vocabulary extraction portion extracts at least one of representative vocabulary from each cluster at S20.

Then, the continuous speech primary recognition portion produces a recognition result by primarily recognizing the continuous speech based on the representative vocabularies that is extracted by the representative vocabulary extraction portion at S30.

Then, the continuous speech final recognition portion finally recognizes the continuous speech based on the recognition result produced by the continuous speech primary recognition portion S40.

In addition, the language model creation portion can create a language model for speech recognition having the representative vocabulary that is extracted by the representative vocabulary extraction portion. The language model creation portion performs this step between S20 and S30, and the continuous speech primary recognition portion can produce the recognition result by use of the language model at S30.

Although it is described above that all elements constituting the embodiment of the present invention are combined into one embodiment or operate in combination, it is not intended that the present invention is limited to what has been described herein. That is, two or more of the elements constituting the embodiment of the present invention can be selectively combined with one another or operate in combination with one another as long as such combination is within the object of the present invention. Moreover, although it is possible that every element is realized as its own individual hardware, it is also possible that some or all of the elements are selectively combined with one another to be realized as a computer program having a program module that performs the combined some or all functions in one or more hardware. Moreover, the embodiment of the present invention can be realized by having said computer program stored in computer-readable media, such as USB memory, CD disk, flash memory, etc., and read and executed by a computer. The computer-readable media can also include magnetic recording media, optical recording media, carrier wave media, etc.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

The descriptions so far is only an example of technical ideas of this present invention, so various permutations, modification, or replacement are possible for people who work in the technical area of the present invention as long as not distracting the original intention of the present invention. Therefore, the embodiment disclosed in the present invention and the attached diagrams are not for restricting the technical ideas of the present invention but for explaining and the technical ideas of the present invention are not to be restricted by the embodiment and the attached diagrams. The protected scope of the present invention shall be understood by the scope of claims below, and all technical ideas which reside in the scope of claims shall be included in the rights of the present invention.

What is claimed is:

1. An apparatus for recognizing continuous speech, comprising:
a cluster creation portion configured to create clusters from continuous speech, each of the clusters including at least one word;
a representative vocabulary extraction portion configured to extract at least one representative word from each of the clusters;
a continuous speech primary recognition portion configured to recognize the continuous speech primarily based on the extracted representative words and produce a recognition result; and
a continuous speech final recognition portion configured to recognize the continuous speech finally based on the produced recognition result.

2. The apparatus of claim 1, wherein the cluster creation portion is configured to create a smaller number of clusters than the number of words included in the continuous speech.

3. The apparatus of claim 1, wherein the cluster creation portion comprises:
a pronunciation array extraction portion configured to extract a pronunciation array from each word; and
a quantization portion configured to create the clusters from the continuous speech according to vector quantization by using the extracted pronunciation array as a vector.

4. The apparatus of claim 1, wherein the representative vocabulary extraction portion is configured to extract the representative word according to a probability of appearance of words in the cluster or in the continuous speech.

5. The apparatus of claim 1, wherein the continuous speech final recognition portion is configured to recognize the continuous speech finally by use of words that are not extracted as the representative word in the continuous speech.

6. The apparatus of claim 1, further comprising:
a language model creation portion configured to create a language model for speech recognition having the extracted representative words included therein.

7. The apparatus of claim 1, wherein the apparatus for recognizing continuous speech is installed in a GPS navigation device and used for recognizing destination place names.

8. A method for recognizing continuous speech, comprising:
creating clusters from continuous speech, each of the clusters including at least one word;
extracting at least one representative word from each of the clusters;
producing a recognition result by recognizing the continuous speech primarily based on the extracted representative words; and
recognizing the continuous speech finally based on the produced recognition result.

9. The method of claim 8, wherein, in the step of creating the clusters, a smaller number of clusters than the number of words included in the continuous speech are created.

10. The method of claim 8, wherein the creating of the clusters comprises:
extracting a pronunciation array from each word; and
creating the clusters from the continuous speech according to vector quantization by using the extracted pronunciation array as a vector.

11. The method of claim 8, wherein, in the step of extracting the representative word, the representative word is extracted according to a probability of appearance of words in the cluster or in the continuous speech.

12. The method of claim 8, wherein, in the step of recognizing the continuous speech finally, the continuous speech is recognized finally by use of words that are not extracted as the representative word from the continuous speech.

13. The method of claim 8, further comprising creating a language model having the extracted representative words.
